(19) United States
(12) Patent Application Publication
(10) Pub. No.: US 2014/0118830 A1
(43) Pub. Date: May 1, 2014

(54) OPTICAL GRATING INCLUDING A SMOOTHING LAYER

(71) Applicants: Ulrich Mueller, Berkeley, CA (US); Jay Daniel, Moraga, CA (US)

(72) Inventors: Ulrich Mueller, Berkeley, CA (US); Jay Daniel, Moraga, CA (US)

(73) Assignee: L-3 Integrated Optical Systems Tinsley, Richmond, CA (US)

(21) Appl. No.: 13/660,585

(22) Filed: Oct. 25, 2012

(51) Int. Cl. G02B 5/18; B05D 5/06

(52) U.S. Cl. 359/572; 427/162

(57) ABSTRACT

An apparatus and method pertaining to an optical grating are disclosed herein. In one embodiment, in response to a light incident on the optical grating, a first component of the light at a first wavelength is selectively reflected while a second component of the light at a second wavelength is selectively rejected. A reflectance efficiency corresponding to the selective reflection of the first component of the light being a function of a surface roughness of an intermediate layer included in the optical grating. And outputting the selective reflection of the first component of the light at the first wavelength to an optical component included in an extreme ultra violet (EUV) lithography system. The first wavelength being an EUV wavelength and the reflectance efficiency maximized at the first wavelength.

### BACKGROUND

The present invention relates to the field of optical components. More particularly, the present invention relates to optical components suitable for use in extreme ultra violet (EUV) wavelengths.

In the EUV wavelength range, reflective optics are used because there are few or no transmissive optics available. One type of reflective optics is an optical grating. An optical grating disperses incoming light in a particular spatial pattern based on wavelength. Because the output of an optical grating comprises angular separation of different wavelengths present within the incoming light in a particular spatial pattern, the optical component that receives the optical grating's output can be strategically positioned relative to the dispersion pattern to receive only the light at a wavelength of interest. The dispersed light at the remaining wavelengths will not reach the recipient optical component and can thus be considered to be rejected by the optical grating. Hence, an optical grating can be considered to reflect incoming light at the wavelength of interest (similar to a mirror) while rejecting incoming light at the other wavelengths (similar to a filter).

In order for an optical grating to reflect EUV wavelength light and reject other wavelengths, such as wavelengths that are longer than EUV wavelengths, with high efficiency, a very smooth grating surface is required. Although optical surfaces may be polished to achieve smoothness, uniformly polishing grating surfaces to the required level of smoothness for use in the EUV wavelength range is not possible.

Thus, it would be beneficial for an optical grating to reflect EUV wavelength light and reject other wavelengths with high efficiency. It would also be beneficial to achieve an optical grating having a very smooth surface at low manufacturing cost. It would additionally be beneficial to fabricate optical gratings having desirable performance characteristics using existing fabrication techniques.

### BRIEF SUMMARY

An apparatus and method pertaining to an optical grating are disclosed herein. In one embodiment, a method for selective treatment of incoming light is disclosed. The method comprises receiving the incoming light at an optical grating. The optical grating including a grating substrate having a grating profile, a smoothing layer over the grating substrate, and a reflective coating over the smoothing layer. The method further comprises, in response to receiving the incoming light, selectively reflecting a first component of the incoming light at a first wavelength and selectively rejecting a second component of the incoming light at a second wavelength. The selectively reflecting of the first component having a reflectance efficiency that is a function of a top surface smoothness of the smoothing layer. The first and second wavelengths are different from each other.

In another embodiment, a method for using an optical grating is disclosed. In response to a light incident on the optical grating, selectively reflecting a first component of the light at a first wavelength while selectively rejecting a second component of the light at a second wavelength. The method further includes outputting the selective reflection of the first component of the light at the first wavelength to an optical component included in an extreme ultra violet (EUV) lithography system. A reflectance efficiency corresponding to the selective reflection of the first component of the light is a function of a surface roughness of an intermediate layer included in the optical grating. The first wavelength is an EUV wavelength and the reflectance efficiency is maximized at the first wavelength.

In still another embodiment, a method for fabricating an optical component is disclosed. The method includes depositing one or more smoothing layers over a grating profile included at a grating substrate, the grating profile configured to facilitate selective reflection of a light at a first wavelength and selective rejection of the light at a second wavelength, the first wavelength being an extreme ultra violet (EUV) wavelength. The method further includes curing the deposited one or more smoothing layers using ozone. Each of the one or more smoothing layers is cured before deposition of the next of the one or more smoothing layers. And a surface roughness of the cured smoothing layers is in a single digit Angstrom range.

In yet another embodiment, a semi-finished optical product is disclosed. The product includes a grating substrate including a square wave cross-sectional shape grating profile, the dimensions of the grating profile selected to facilitate selective reflection of light at a first wavelength and selective rejection of the light at a second wavelength. The product further includes one or more smoothing layers over the grating substrate. The smoothing layers is configured to attenuate a surface roughness of the grating profile by having a smoothing layers surface roughness that is less than the surface roughness of the grating profile by a factor of approximately 4 to 7.5 while retaining the selective reflection and rejection properties of the grating profile.

Other features and aspects of the invention will become apparent from the following detailed description, taken in conjunction with the accompanying drawings which illustrate, by way of example, the features in accordance with the embodiments.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example flow diagram showing operations for fabrication of an optical grating having high reflectivity of extreme ultra violet (EUV) wavelengths according to some embodiments.

FIGS. 2A-2D illustrate cross sections of an example optical grating at different fabrication points of the flow diagram of FIG. 1.

FIG. 3 illustrates a cross section of an example optical grating that is similar to the optical grating of FIG. 2D except its grating profile is curved.

FIG. 4A-4B illustrate example plots showing roughness of the optical grating before and after deposition of the smoothing layer.

FIG. 5 illustrates an example flow diagram showing operations or use of the optical grating according to some embodiments.

FIG. 6 illustrates operation of the optical grating upon receipt of an incoming or incident light according to some embodiments.

FIGS. 7A-7C illustrate reflectance and rejection performance characteristics of the optical grating according to some embodiments.

The headings provided herein are for convenience only and do not necessarily affect the scope or meaning of the terms used.

### DETAILED DESCRIPTION

Described in detail below is an optical grating comprising a grating substrate, a smoothing layer over the grating substrate, and a reflective coating over the smoothing layer. The smoothing layer reduces the surface roughness of the grating substrate, and the surface roughness of the reflective coating, in turn, is based on the surface roughness of the smoothing layer underneath it. The smoother the surface roughness of the smoothing layer, the better the reflectance efficiency/characteristic of the optical grating, especially at a wavelength of interest. Light incident on the optical grating is selectively reflected to output a component of the incident light at the wavelength of interest while selectively rejecting component(s) of the incident light at wavelengths that are different from the wavelength of interest.

Various modifications to the preferred embodiments will be readily apparent to those skilled in the art, and the generic principles defined herein may be applied to other embodiments and applications without departing from the scope of the invention. Moreover, in the following description, numerous details are set forth for the purpose of explanation. However, one of ordinary skill in the art will realize that the invention might be practiced without the use of these specific details. In other instances, well-known structures and processes are not shown in block diagram form in order not to obscure the description of the invention with unnecessary detail. Thus, the present invention is not intended to be limited to the embodiments shown, but is to be accorded the widest scope consistent with the principles and features disclosed herein.

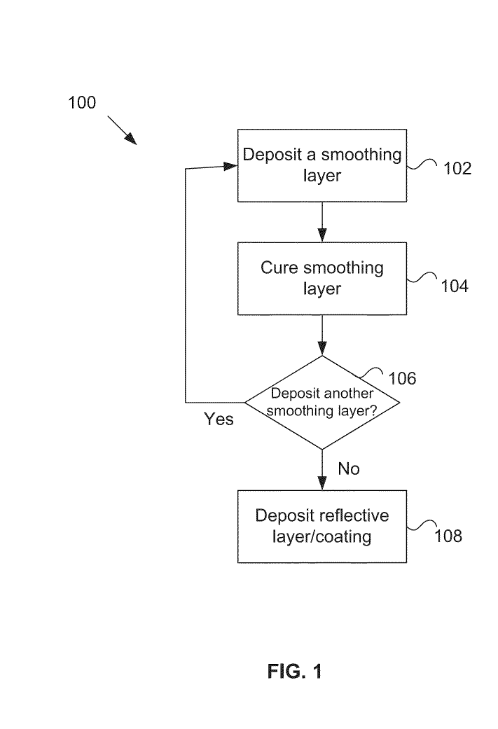

FIG. 1 illustrates an example flow diagram 100 showing operations for fabrication of an optical grating having high reflectivity of extreme ultra violet (EUV) wavelengths according to some embodiments. The optical grating is also referred to as a grating, binary grating, diffraction grating, smooth grating, smoothed grating, and other similar variants. The optical grating comprises a grating substrate and multi-layers deposited over the grating substrate.

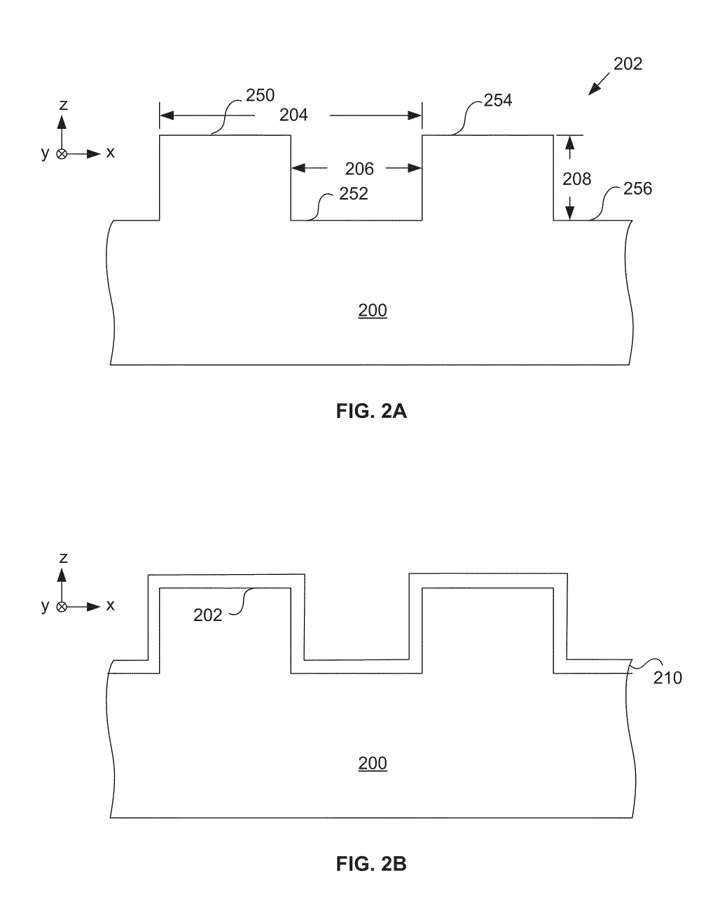

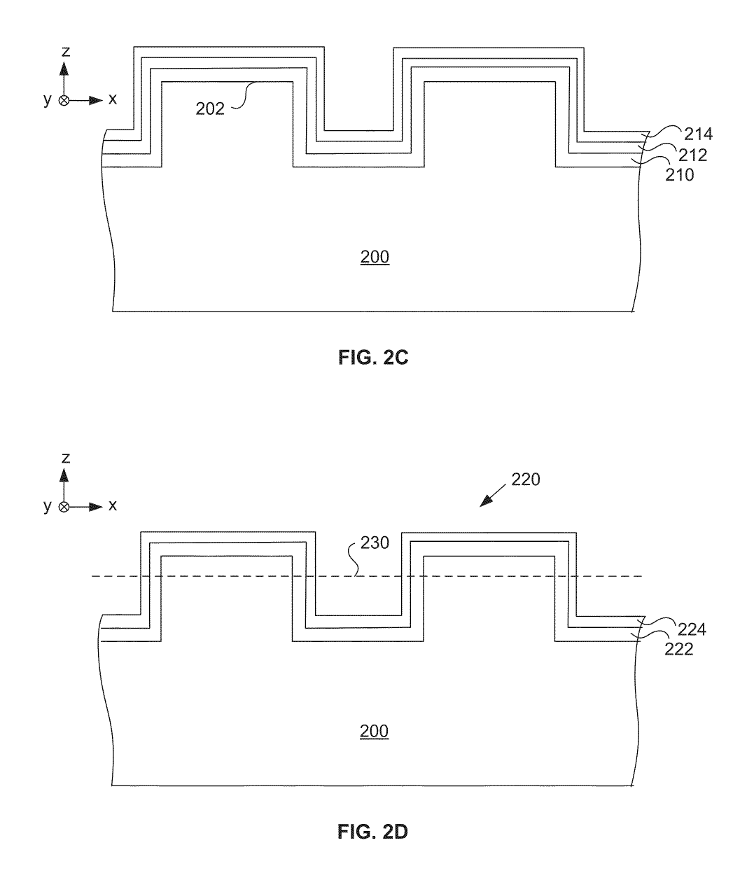

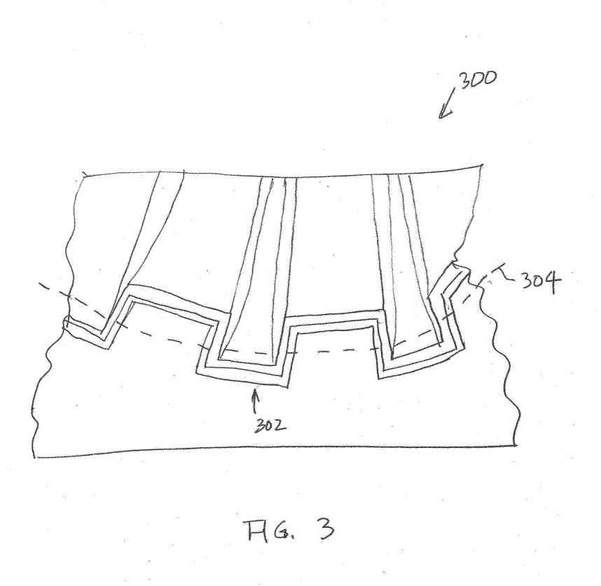

FIG. 2A illustrates a cross section of an example grating substrate 200 having a grating profile 202 at a top side. The grating profile 202 comprises a periodic two-level step profile (a square wave type) having a grating period 204, a feature dimension 206, and a grating height 208. The grating period 204 is selected based on the wavelength(s) to be rejected by the finished optical grating. The feature dimension 206 is ½ of the grating period 204 (the duty cycle is ½). The grating height 208 (also referred to as a grating depth) is selected to be ¼ of the wavelength λ of the light to be rejected. For example, in EUV lithography steppers, a 10.6 μm laser light is used to generate the desired 13.5 nm EUV light. However, the generated 13.5 nm EUV light retains a portion of 10.6 μm laser light. Incoming light comprising the 13.5 nm EUV light and the 10.6 μm laser light component is then collected by EUV collector optics that includes an optical grating. In order for the optical grating under consideration to reflect the 13.5 nm EUV light while rejecting the 10.6 μm laser light, the grating period 204 is configured to be on the order of 0.5 mm and the grating height 206 is 10.6 μm/4=2.65 μm. In some embodiments, for example where the main plane of the grating profile 202 is curved or non-planar (e.g., major plane 304 shown in FIG. 3), the grating height 208 can be less than ¼ of the wavelength λ of the light to be rejected or some other dimension relative to the wavelength λ of the light to be rejected.

Conventional fabrication techniques such as, but not limited to, lithography, diamond turning, mechanical ruling, ruling engines, imprinting, laser machining, or the like can be used to fabricate grating substrate 200. The grating substrate 200 comprises aluminum, copper, copper alloys, silicon, silicon carbide, nickel, metal, lithium aluminosilicate glass-ceramic (e.g., Zerodur™ made by Schott Glass), or other suitable materials.

At a block 102 of FIG. 1, a smoothing layer 210 is deposited over the grating profile 202 of the grating substrate 200. FIG. 2B illustrates a cross section of the grating substrate 200 with the smoothing layer 210. In some embodiments, the smoothing layer 210 is deposited by spin coating a flowable oxide material onto the grating profile 202. In some embodiments, flowable oxide comprises a liquid solution of hydrogen silsesquioxane (HSQ) in a carrier solvent. Suitable carrier solvents include, but are not limited to, methyl isobutyl ketone (MIBK) or volatile methyl siloxane (VMS). The flowable oxide material can be a flowable oxide manufactured by Dow Corning Corporation. Alternatively, the smoothing layer 210 can be deposited by spin coating a dielectric material carried in a carrier solvent, an inorganic polymer carried in a carrier solvent, a photoresist material carried in a carrier solvent, a polyimide carried in a carrier solvent, or other material that cures to an amorphous film and provides the smoothing feature disclosed herein. In another embodiment, the smoothing layer 210 may be deposited using dip coating.

The smoothing layer 210 (also referred to as a smoothing coat or film) has a thickness of about 200 to 800 nm, and can be up to 1 μm thick. The smoothing layer 210 enjoys a high uniformity of thickness over the entire top surface of the grating substrate 200, the uniformity being within an order of about 20 nm. When spin coating is used to deposit the smoothing layer 210, the thickness uniformity can be controlled as a function of radius by varying the spin velocity and acceleration over time. The thickness of smoothing layer 210 is configured to be at least thick enough to decrease the impact of or attenuate the surface roughness of the grating substrate 200 while not being too thick to change the grating profile (or otherwise degrade the selective reflectance and rejection properties intended by the grating profile/dimensions included in the grating substrate 200).

Next at a block 104, a curing technique is used to harden the deposited smoothing layer 210. The curing technique comprises ozone curing the deposited smoothing layer 210. In one embodiment, the deposited smoothing layer 210 is exposed to one or more ultraviolet (UV) lamps for 12 to 15 hours at ambient pressure and temperature. The one or more UV lamps are positioned close to the surface of the deposited smoothing layer 210 and the output of the UV lamps converts the oxygen in the air into ozone. The ozone, in turn, cures or hardens the deposited smoothing layer 210. Unlike with conventional curing techniques, for example, to cure a photoresist layer in integrated circuit (IC) fabrication, neither a vacuum nor high temperature is required. High temperature during fabrication subjects components to thermal damage and is avoided when possible. In an alternative embodiment, extra oxygen is introduced to the one or more UV lamps—so that more oxygen is available to be converted into ozone—to speed up the curing time. In still another alternative, the ozone can be sourced directly from an ozone generating and outputting system and such ozone can cure or harden the deposited smoothing layer 210.

The smoothing layer 210 is an overcoat over the grating substrate 200 to attain a desired surface smoothness that is not otherwise possible with the grating substrate 200 alone. As will be discussed in detail below, the reflectivity of the optical grating is a function of the surface smoothness. To this end, in some embodiments more than one smoothing layer can be deposited over the grating substrate 200. Each smoothing layer reduces the original roughness of the grating substrate 200 by a certain amount, such as reducing roughness by a factor of between approximately 4 to 7.5. Nevertheless, the increase in smoothness from each successive smoothing layer is balanced against factors such as, but not limited to: (1) each successive smoothing layer adds to the fabrication time (because the latest smoothing layer is cured for approximately 12 to 15 hours before the next smoothing layer is deposited), (2) each successive smoothing layer increases the chance of introducing surface non-uniformity (e.g., bubbles or other artifacts), and/or (3) the grating profile 202 degrades (e.g., changes shape) with each successive smoothing layer.

If the optical grating is to include more than one smoothing layer (yes branch of block 106), then flow diagram 100 returns to blocks 102 and 104 to respectively deposit and cure the next smoothing layer. Such iteration can occur one or more times depending on the amount of smoothness desired and/or the number of smoothing layers to be included in the optical grating. In all, the optical grating can include one or more smoothing layers, up to about five smoothing layers.

FIG. 2C illustrates a cross section of an example partially fabricated optical grating including three smoothing layers. The smoothing layer 210 is provided over the grating substrate 200, a second smoothing layer 212 is provided over the smoothing layer 210, and a third smoothing layer 214 is provided over the second smoothing layer 212. When more than one smoothing layer is included in the optical grating, the plurality of smoothing layers is also referred to as smoothing multi-layers, a smoothing multi-layer stack, a smoothing stack, or other similar variants. The thickness of each of the smoothing layers 210, 212, 214 can be between 100 to 600 nm or up to 1 μm thick. In some embodiments, the thickness of each of smoothing layers 210, 212, 214 may be thinner than if only a single smoothing layer (e.g., smoothing layer 210) is included in the optical grating. In some embodiments, the thickness of each of smoothing layers 210, 212, 214 may be different from each other, such as smoothing layer 212 having a thickness smaller than smoothing layer 210 and smoothing layer 214 having a thickness smaller than smoothing layer 212.

Once the desired number of smoothing layers has been deposited (and cured) or the optical grating includes a single smoothing layer (e.g., smoothing layer 210) (no branch of block 106), the fabrication process proceeds to block 108. At block 108, a reflective coating or layer is deposited over the smoothing layer(s). FIG. 2D illustrates a cross section of a finished optical grating 220 including a reflective coating 224 provided over a smoothing layer 222. The reflective coating 224 comprises one or more layers of reflective material. When the reflective coating 224 comprises multi-layers, the reflective coating 224 comprises, for example, Mo/Si, Mo₂C/Si, Mo/Be, MoRu/Be, or other materials that reflect light at the wavelength(s) of interest (e.g., 13.4 nm, 13.5 nm, EUV wavelength) at or above a pre-defined threshold efficiency level (e.g., 50%, 60%, etc.). In the multi-layer implementation, the reflective coating 224 is also referred to as a multi-layer reflector, a reflective multi-layer, a reflective multi-layer stack, and the like. The smoothing layer 222 comprises one or more layers of the smoothing layers. For instance, as discussed above, the smoothing layer 222 can comprise a single smoothing layer (e.g., smoothing layer 210 shown in FIG. 2B) or a plurality of smoothing layers (e.g., smoothing layers 210, 212, 214 shown in FIG. 2C).

FIGS. 2B and 2C illustrate examples of a semi-finished product (also referred to as a semi-finished optical grating or semi-fabricated optical grating)—a grating profile with one or more smoothing layer overcoat—to which the reflective coating may be added (e.g., block 108) in the same or separate fabrication process from the semi-finished product.

In some embodiments, it is contemplated that one or more blocks of flow diagram 100 is wholly or in part performed using robotics, a control computing system, and other automated fabrication equipment. The robotics, control computing system, or automated fabrication equipment includes processors, memories, computer- or machine-executable instructions, sensors, and other components to automate fabrication of the optical grating 220.

Optical grating 220 is sized according to customer requirements or particular use within a larger system. For example, the optical grating 220 can be sized anywhere between about 20 mm to 1 m in diameter. As another example, the optical grating 220 has a diameter of 400 mm or 600 mm.

Additionally, the (major) plane of the grating profile 202 of the optical grating 220 can be flat, planar, or curved. The optical grating 220 shown in FIG. 2D has a major plane 230 that is flat. FIG. 3 illustrates a cross section of an example optical grating 300 that is similar to optical grating 220 except a (major) plane 304 of a grating profile 302 of the optical grating 300 is curved, e.g., a concave curve. Although not shown in FIG. 3, the optical grating 300 as a whole may be a spherical or aspherical shape such as a salad bowl with deep edges and other features.

During fabrication of the grating substrate 200, such as by diamond turning, roughness, ripples, or surface structures are left behind on the top surface of the grating substrate 200 (e.g., on each of top surfaces 250, 252, 254, and 256 in FIG. 2A). If the reflective coating 224 is deposited directly over the grating substrate 200, the degree of reflectivity that the reflective coating 224 is capable of is reduced because the top surface of the reflective coating 224 is also rough due to the surface roughness of the grating substrate 200 underneath it. The reflectivity efficiency of the reflective coating 224 is limited by the grating substrate 200's roughness/smoothness. In contrast, by including one or more smoothing layers between the grating substrate 200 and the reflective coating 224, the surface roughness of the grating substrate 200 is attenuated and prevented from transferring or carrying over to the top surface of the reflective coating 224. In turn, the reflective coating 224 more efficiently reflects the wavelength of interest.

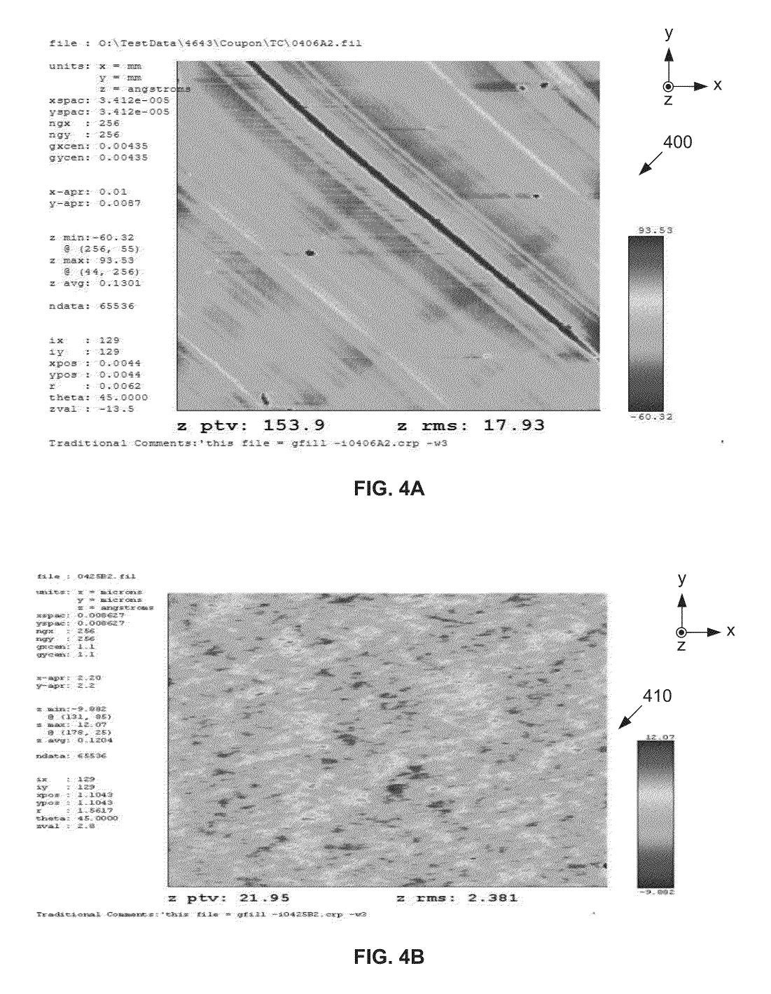

FIG. 4A illustrates an example plot 400 showing the surface roughness before smoothing. The measured roughness is of a 2 μm×2 μm portion of the top surface of the grating substrate 200 made of nickel. The different gradations of plot 400 correspond to different amounts of surface roughness (along the z-axis or into/out of the page) within this 2 μm×2 μm window. In particular, plot 400 shows the surface roughness of the grating substrate 200 ranging between a maximum of 93.53 Å and a minimum of −60.32 Å, and an overall roughness of 17.93 Å. FIG. 4B illustrates an example plot 410 showing the surface roughness after smoothing. The measured roughness is of a 2 μm×2 μm portion of the top surface of the smoothing layer overcoat provided over the grating substrate 200 (also made of nickel) (e.g., surface roughness after smoothing). The different gradations of plot 410 correspond to different amounts of surface roughness (along the z-axis or into/out of the page) within this 2 μm×2 μm window. Plot 410 shows the surface roughness of the smoothing layer overcoat (or in other words, the grating substrate 200 with the smoothing layer overcoat) ranging between a maximum of 12.07 Å and a minimum of −9.882 Å, and an overall roughness of 2.381 Å. The roughness reduction shown in plot 410 corresponds to a reduction by a factor of about 7.5 over the roughness shown in plot 400. Accordingly, the optical grating 220 comprises an optical grating having a surface finish in the (single digit) Angstrom range.

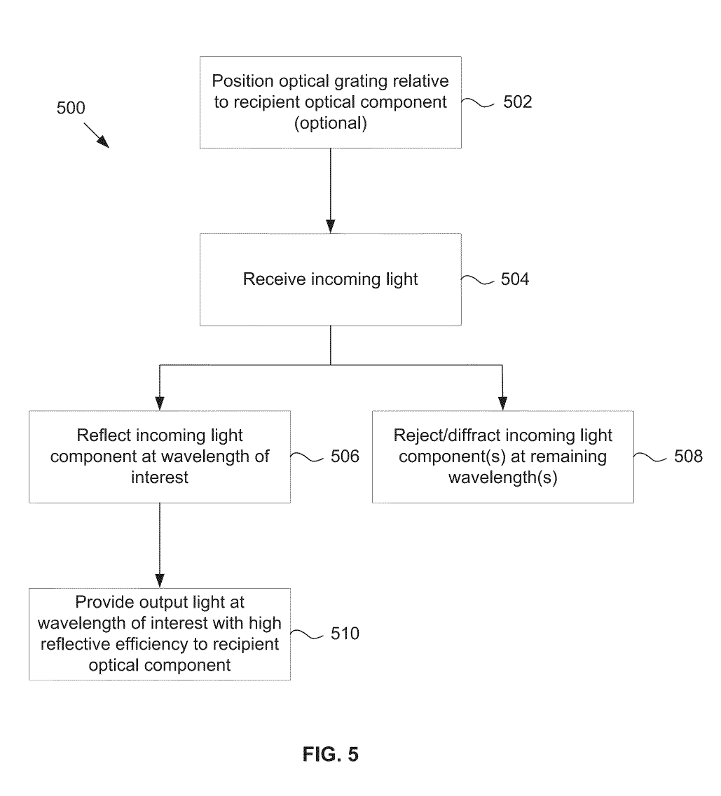

FIG. 5 illustrates an example flow diagram 500 showing operations or use of the optical grating 220 according to some embodiments. At a block 502, the optical grating 220 and the optical component that will be receiving the output of the optical grating 220 (also referred to as the recipient optical component or the optical component (immediately) downstream of the optical grating 220) are positioned relative to each other so that the output light from the optical grating 220 at the wavelength of interest will be received or incident on such optical component. Because the output of the optical grating 220 comprises a particular diffraction pattern, in which output light at different wavelengths are angularly separated from each other, the recipient optical component can be selectively positioned to receive the output light at the wavelength of interest. Alternatively, block 502 may be optional if the reflectivity efficiency characteristic of the optical grating 220 as a function of wavelength is sufficient to filter out incoming light component(s) at undesirable wavelength(s).

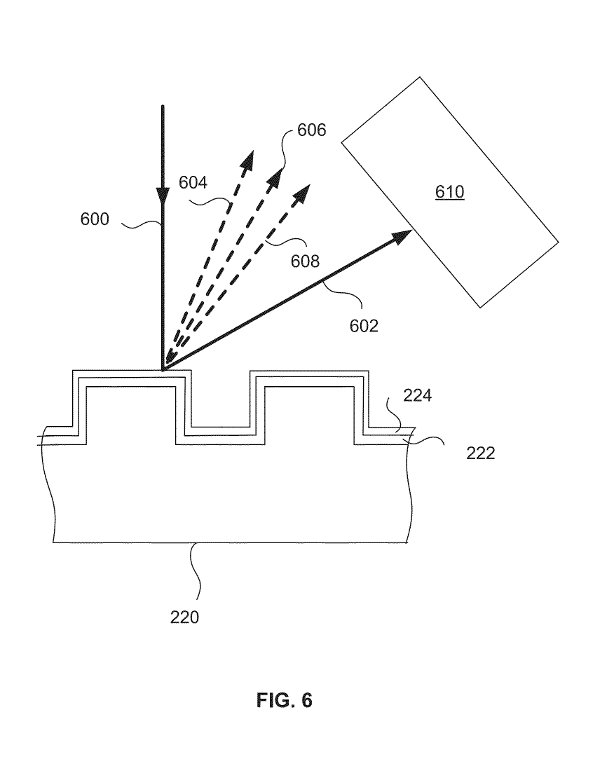

Once the optical grating 220 and recipient optical component are appropriately positioned relative to each other, the optical grating 220 receives incoming or incident light at a block 504. FIG. 6 illustrates an incoming or incident light 600 being received on the reflective coating 224 of the optical grating 220. The reflective coating 224—which has a smooth top surface due to the smoothing layer 222—simultaneously selectively reflects the component of the incoming light 600 at the wavelength of interest (block 506) while selectively rejecting (or filtering out) the component(s) of the incoming light 600 at the remaining wavelength(s) (block 508). The optical grating 220 exhibits high reflectivity of the component of the incoming light 600 at the wavelength of interest relative to components of the incoming light 600 at wavelengths other than the wavelength of interest.

Then at a block 510, the optical grating 220 provides an output light at the wavelength of interest (output light 602 in FIG. 6) to the recipient optical component 610. The output light 602 comprises the highly reflected input light component at the wavelength of interest. The output light 602 is also referred to as the reflected light of the optical grating 220. The input light components at wavelengths other than the wavelength of interest are shown rejected in FIG. 6, such as rejected input light components 604, 606, and 608.

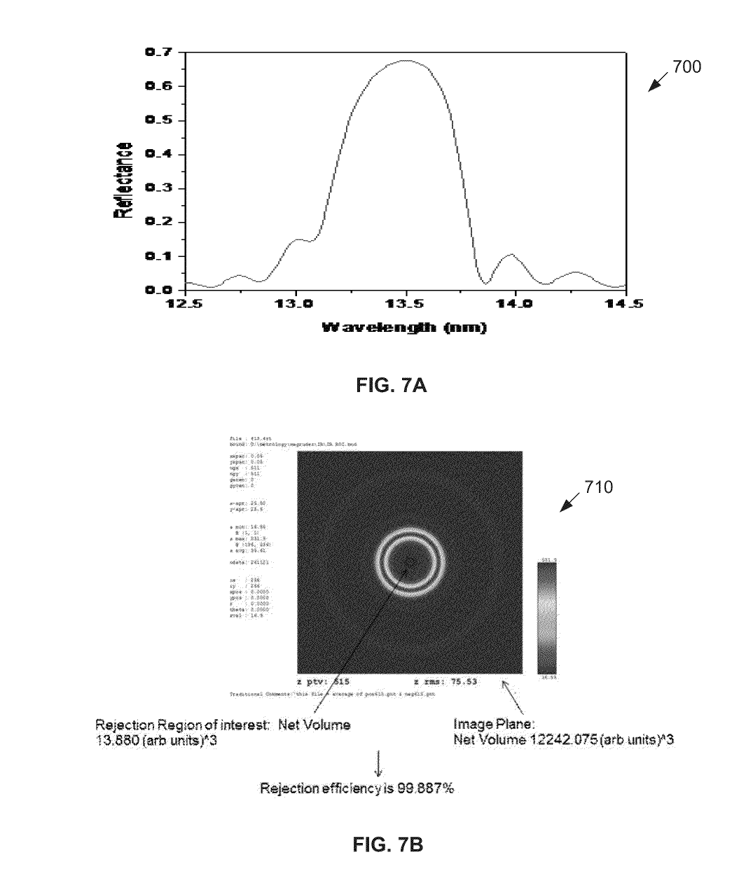

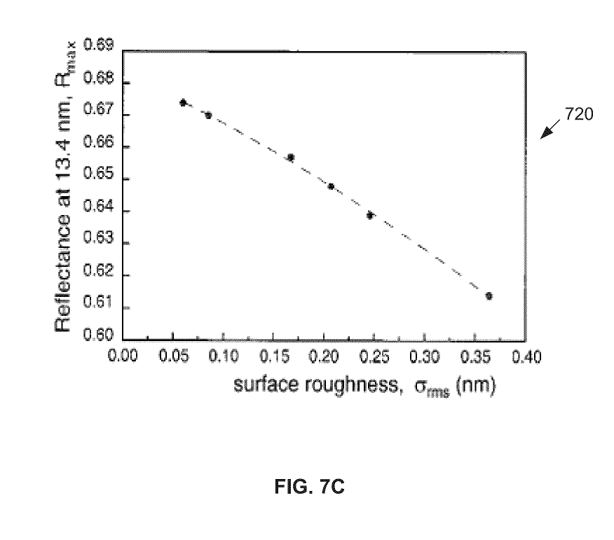

FIG. 7A illustrates a plot 700 showing the reflectance characteristic of the optical grating 220 as a function of wavelength. At a wavelength of 13.5 nm (e.g., the wavelength of interest), a reflectance of about 70% is achieved due to the smoothness imparted by the smoothing layer 222 below the reflective coating 224. At wavelengths below or above 13.5 nm (e.g., wavelengths not of interest), the reflectance very rapidly falls off so that within less than 1 nm on either side of 13.5 nm, the reflectance is less than 5%. The plot 700 corresponds to the optical grating 220 having a flat grating profile.

FIG. 7B illustrates the rejection efficiency of the optical grating 220 on a desired rejection area in the center of an image plane 710. A rejection efficiency of 99.887% of 10.6 μm incident light at the center of image plane 710 is shown. Such rejection efficiency is achieved by the optical grating 220 similar to that used for FIG. 7A and having a flat grating profile. FIG. 7B illustrates the optical grating 220's ability to both reject with nearly 100% efficiency the undesirable wavelengths (e.g., wavelengths that are not 13.5 nm) and to reject undesirable incoming light component(s) at a pre-defined rejection area (e.g., location of downstream optical components).

FIG. 7C illustrates an example plot 720 showing the reflectance characteristic of an optical grating as a function of surface roughness of the layer immediately below the reflective coating. In plot 720, the reflective coating comprises a Mo/Si multi-layer stack and the reflectance is of 13.4 nm wavelength light. The reflectance is about 67.5% when the layer below the reflective coating has a roughness of 0.05 nm, and decreases to about 61.5% reflectance for a roughness of about 0.365 nm. Thus, as the roughness of the layer immediately below the reflective coating decreases, the reflectance efficiency (the amplitude or intensity of the reflected wave relative to the amplitude or intensity of the incident wave) of the optical grating at the wavelength of interest increases because the surface roughness/smoothness of the reflective coating is a function of the roughness/smoothness of the layer immediately below the reflective coating. The one or more smoothing layer(s) below the reflective coating has a low enough surface roughness, such low surface roughness being imputed to the reflective coating, so as to improve the reflective characteristics of the reflective coating. Without the smoothing layer(s) below the reflective coating layer, the reflective characteristics of the reflective coating would be lower than shown in plots 700 and 720 due to the high surface roughness of the grating substrate underneath the reflective coating. In some embodiments, the smoothing layer(s) below the reflective coating has a low enough surface roughness to facilitate or ensure that the reflective coating has a reflectance of approximately 70% at the wavelength of interest (EV wavelength, 13.4 nm, 13.5 nm). In other embodiments, the surface roughness of the smoothing layer(s) of between approximately 0.35 nm to 0.05 nm corresponds to the reflective coating provided over the smoothing layer(s) having a reflectance efficiency of between approximately 61.5% to 67.5%, respectively, for incoming light at 13.4 nm wavelength.

The optical grating 220 having the requisite surface smoothness and performance characteristics described above is suitable for use in, but not limited to, EUV lithography systems, non-glare liquid crystal display (LCD) screens, and other applications that can benefit from selective rejection of specific wavelength/frequency of incident light while efficiently reflecting other specific wavelength/frequency of the incident light. For example, in EUV lithography stepper systems, the light source comprises a 10.6 μm laser that is converted into 13.5 nm light before reaching EUV collector optics. However, the 13.5 nm light that is transmitted to the EUV collector optics still retains at least a light component at 10.6 μm. If this 10.6 μm light component (also referred to as 10.6 μm laser light) is allowed to be transmitted to the stepper downstream, stepper components will be damaged. In order to prevent such damage, the 10.6 μm light component can be removed or rejected from the overall light transmitted to the EUV collector optics using the optical grating 220 included in the EUV collector optics. The optical grating 220 rejects the 10.6 μm light component in the overall transmitted light while still reflecting the EUV light component (the 13.5 nm light) due to the smoothing layer 222 provided between the grating substrate 200 and reflective coating 224. Thus the optical grating 220 eliminates a significant roadblock toward commercialization of EUV lithography.

In this manner, controlled deposition and curing of one or more smoothing layers 222 between a grating substrate 200 having a particular grating profile 202 and a reflective coating 224 is used to compensate for the surface roughness present on the grating substrate 200. The effect of the surface roughness of the grating substrate 200 is attenuated by the addition of one or more smoothing layers 222 provided over the grating substrate 200 while still maintaining the shape and dimensions of the grating profile of the grating substrate 200. In turn, the surface roughness of the reflective coating 224 is based on the surface roughness of the smoothing layer(s) 222. The thickness of the reflective coating 224 is substantially smaller than the thickness of the smoothing layer(s) 222. The reflective coating 224 takes on the contours of the underlying smoothing layer(s) 222, the reflective coating 224 alone having minimal or no smoothing effect.

The finished optical grating 220 has a surface roughness in the Angstrom range. Such surface roughness or smoothness results in the optical grating 220 being capable of reflecting a component of the incident light at a wavelength of interest with an efficiency level that it otherwise would not be able to absent the smoothing layer 222. As an example, the reflective efficiency at the wavelength of interest can be upwards of 70%. At the same time, the optical grating 220 rejects the remaining component(s) of the incident light at other wavelengths—by reflecting such incident light components at de minimus levels and/or diffracting such incident light components at angular positions that will not reach a recipient/downstream optical component.

Example 1 can include or use a method for selective treatment of incoming light, such as can include or use receiving the incoming light at an optical grating, the optical grating comprising a grating substrate having a grating profile, a smoothing layer over the grating substrate, and a reflective coating over the smoothing layer; and, in response to receiving the incoming light, selectively reflecting a first component of the incoming light at a first wavelength and selectively rejecting a second component of the incoming light at a second wavelength, wherein the first and second wavelengths are different from each other and the selectively reflecting of the first component having a reflectance efficiency that is a function of a top surface smoothness of the smoothing layer.

Example 2 can include, or can optionally be combined with the method of Example 1, to optionally include the reflectance efficiency at the first wavelength being approximately 70% and the reflectance efficiency comprising an amount of an amplitude or intensity of the reflected first component of the incoming light relative to an amplitude or intensity of the first component of the incoming light.

Example 3 can include, or can optionally be combined with the method of one or any combination of Examples 1 or 2 to optionally include positioning a recipient optical component relative to the optical grating for the reflected first component of the incoming light to be incident at the recipient optical component.

Example 4 can include, or can optionally be combined with the method of one or any combination of Examples 1 through 3 to optionally include the first wavelength being an extreme ultra violet (EUV) wavelength.

Example 5 can include, or can optionally be combined with the method of one or any combination of Examples 1 through 4 to optionally include the grating profile being one of a flat grating profile, a curved grating profile, or a concave grating profile.

Example 6 can include, or can optionally be combined with the method of one or any combination of Examples 1 through 5 to optionally include the grating profile comprising a periodic two-level step profile.

Example 7 can include, or can optionally be combined with the method of one or any combination of Examples 1 through 6 to optionally include the reflective coating comprising one or more reflective coatings.

Example 8 can include, or can optionally be combined with the method of one or any combination of Examples 1 through 7 to optionally include the smoothing layer comprising one or more smoothing layers.

Example 9 can include, or can optionally be combined with the method of one or any combination of Examples 1 through 8 to optionally include the smoothing layer comprising hydrogen silsesquioxane (HSQ), a dielectric, an inorganic polymer, a photoresist, a polyimide, an amorphous film, or an ozone cured material.

Example 10 can include, or can optionally be combined with the method of one or any combination of Examples 1 through 9 to optionally include a thickness of the smoothing layer comprising 200 to 800 nm, 100 to 600 nm, up to approximately 1 μm, or thick enough to reduce a surface roughness of the grating substrate by a factor of approximately 4 to 7.5.

Example 11 can include, or can optionally be combined with the method of one or any combination of Examples 1 through 10 to optionally include the optical grating being included in an extreme ultra violet (EUV) lithography system.

Example 12 can include, or can optionally be combined with the subject matter of one or any combination of Examples 1 through 11 to include, a method for using an optical grating, such as can include, in response to a light incident on the optical grating, selectively reflecting a first component of the light at a first wavelength while selectively rejecting a second component of the light at a second wavelength, a reflectance efficiency corresponding to the selective reflection of the first component of the light being a function of a surface roughness of an intermediate layer included in the optical grating; and outputting the selective reflection of the first component of the light at the first wavelength to an optical component included in an extreme ultra violet (EUV) lithography system, wherein the first wavelength is an EUV wavelength and the reflectance efficiency is maximized at the first wavelength.

Example 13 can include, or can optionally be combined with the subject matter of Example 12 to optionally include the first wavelength being 13.5 nm or 13.4 nm.

Example 14 can include, or can optionally be combined with the subject matter of one or any combination of Examples 12 through 13 to optionally include the selective rejection of the second component of the light comprising preventing the second component of the light from being outputted to the optical component.

Example 15 can include, or can optionally be combined with the subject matter of one or any combination of Examples 12 through 14 to optionally include the intermediate layer comprising one or more intermediate layers.

Example 16 can include, or can optionally be combined with the subject matter of one or any combination of Examples 12 through 15 to optionally include the intermediate layer comprising an ozone cured smoothing layer.

Example 17 can include, or can optionally be combined with the subject matter of one or any combination of Examples 12 through 16 to optionally include the intermediate layer comprising hydrogen silsesquioxane (HSQ), a dielectric, an inorganic polymer, a photoresist, a polyimide, an amorphous film, or an ozone cured material.

Example 18 can include, or can optionally be combined with the subject matter of one or any combination of Examples 12 through 17 to optionally include the optical grating including a reflective coating over the intermediate layer and the intermediate layer provided over a grating substrate having a grating profile.

Example 19 can include, or can optionally be combined with the subject matter of one or any combination of Examples 12 through 18 to optionally include a major plane of the grating profile being flat, planar, curved, or concave.

Example 20 can include, or can optionally be combined with the subject matter of one or any combination of Examples 12 through 19 to optionally include a cross-section of the grating profile comprising a square wave cross-sectional shape.

Example 21 can include, or can optionally be combined with the subject matter of one or any combination of Examples 12 through 20 to optionally include a thickness of the intermediate layer comprising 200 to 800 nm, 100 to 600 nm, up to approximately 1 μm, or thick enough to reduce a surface roughness of the grating substrate by a factor of approximately 4 to 7.5.

Example 22 can include, or can optionally be combined with the subject matter of one or any combination of Examples 12 through 21 to optionally include the surface roughness of the intermediate layer being in a single digit Angstrom range.

Example 23 can include, or can optionally be combined with the subject matter of one or any combination of Examples 12 through 22 to optionally include the reflectance efficiency at the first wavelength being approximately 70%.

Example 24 can include, or can optionally be combined with the subject matter of one or any combination of Examples 12 through 23 to optionally include the second wavelength comprising a wavelength at least within approximately 1 nm on either side of the first wavelength.

Example 25 can include, or can optionally be combined with the subject matter of one or any combination of Examples 12 through 24 to optionally include the selectively rejecting of the second component of the light comprising diffracting the second component of the light at an angular position not coincident with the optical component.

Example 26 can include, or can optionally be combined with the subject matter of one or any combination of Examples 12 through 25 to optionally include the selectively rejecting of the second component of the light comprising outputting the second component of the light at a low reflectivity relative to the first component of the light.

Example 27 can include, or can optionally be combined with the subject matter of one or any combination of Examples 1 through 26 to include, a method for fabricating an optical component, such as can include, depositing one or more smoothing layers over a grating profile included at a grating substrate, the grating profile configured to facilitate selective reflection of a light at a first wavelength and selective rejection of the light at a second wavelength, the first wavelength being an extreme ultra violet (EUV) wavelength; and curing the deposited one or more smoothing layers using ozone, wherein each of the one or more smoothing layers is cured before deposition of the next of the one or more smoothing layers, and wherein a surface roughness of the cured smoothing layers is in a single digit Angstrom range.

Example 28 can include, or can optionally be combined with the subject matter of Example 27 to optionally include the depositing of the one or more smoothing layers comprising spin coating the one or more smoothing layers.

Example 29 can include, or can optionally be combined with the subject matter of one or any combination of Examples 27 through 28 to optionally include a thickness of the one or more smoothing layers comprising 200 to 800 nm, 100 to 600 nm, up to approximately 1 μm, or thick enough to reduce a surface roughness of the grating substrate by a factor of approximately 4 to 7.5.

Example 30 can include, or can optionally be combined with the subject matter of one or any combination of Examples 27 through 29 to optionally include the one or more smoothing layers comprising hydrogen silsesquioxane (HSQ), a dielectric, an inorganic polymer, a photoresist, a polyimide, or an amorphous film.

Example 31 can include, or can optionally be combined with the subject matter of one or any combination of Examples 27 through 30 to optionally include depositing one or more reflective layers over the cured smoothing layers, a surface roughness of the reflective layers being approximately the same as the surface roughness of the cured smoothing layers.

Example 32 can include, or can optionally be combined with the subject matter of one or any combination of Examples 27 through 31 to optionally include approximately 70% of the light at the first wavelength incident on the reflective layers being selectively reflected.

Example 33 can include, or can optionally be combined with the subject matter of one or any combination of Examples 27 through 32 to optionally include a reflectance efficiency of the reflective layers at the first wavelength being a function of the surface roughness of the cured smoothing layers.

Example 34 can include, or can optionally be combined with the subject matter of one or any combination of Examples 1 through 33 to include, a semi-finished optical product, such as can include a grating substrate including a square wave cross-sectional shape grating profile, dimensions of the grating profile selected to facilitate selective reflection of light at a first wavelength and selective rejection of the light at a second wavelength; and one or more smoothing layers over the grating substrate, the smoothing layers configured to attenuate a surface roughness of the grating profile by having a smoothing layers surface roughness that is less than the surface roughness of the grating profile by a factor of approximately 4 to 7.5 while retaining the selective reflection and rejection properties of the grating profile.

Example 35 can include, or can optionally be combined with the subject matter of Example 34 to optionally include one or more reflective layers over the smoothing layers, a reflectance efficiency of the reflective layers at the first wavelength being a function of the smoothing layers surface roughness.

Example 36 can include, or can optionally be combined with the subject matter of one or any combination of Examples 34 through 35 to optionally include wherein the first wavelength is 13.5 nm and the reflectance efficiency at the first wavelength is approximately 70%.

Example 37 can include, or can optionally be combined with the subject matter of one or any combination of Examples 34 through 36 to optionally include wherein the smoothing layers comprises ozone cured smoothing layers.

Example 38 can include, or can optionally be combined with the subject matter of one or any combination of Examples 34 through 37 to optionally include wherein the smoothing layers comprises hydrogen silsesquioxane (HSQ), a dielectric, an inorganic polymer, a photoresist, a polyimide, or an amorphous film.

Example 39 can include, or can optionally be combined with any portion or combination of any portions of any one or more of Examples 1 through 38 to include, subject matter that can include means for performing any one or more of the functions of Examples 1 through 38.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

Although the present invention has been described in connection with some embodiments, it is not intended to be limited to the specific form set forth herein. One skilled in the art would recognize that various features of the described embodiments may be combined in accordance with the invention. Moreover, it will be appreciated that various modifications and alterations may be made by those skilled in the art without departing from the spirit and scope of the invention.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for selective treatment of incoming light, the method comprising:
receiving the incoming light at an optical grating, the optical grating comprising a grating substrate having a grating profile, a smoothing layer over the grating substrate, and a reflective coating over the smoothing layer; and
in response to receiving the incoming light, selectively reflecting a first component of the incoming light at a first wavelength and selectively rejecting a second component of the incoming light at a second wavelength, wherein the first and second wavelengths are different from each other and the selectively reflecting of the first component having a reflectance efficiency that is a function of a top surface smoothness of the smoothing layer.

2. The method of claim 1, wherein the reflectance efficiency at the first wavelength is approximately 70% and the reflectance efficiency comprises an amount of an amplitude or intensity of the reflected first component of the incoming light relative to an amplitude or intensity of the first component of the incoming light.

3. The method of claim 1, further comprising positioning a recipient optical component relative to the optical grating for the reflected first component of the incoming light to be incident at the recipient optical component.

4. The method of claim 1, wherein the first wavelength is an extreme ultra violet (EUV) wavelength.

5. The method of claim 1, wherein the grating profile is one of a flat grating profile, a curved grating profile, or a concave grating profile.

6. The method of claim 1, wherein the grating profile comprises a periodic two-level step profile.

7. The method of claim 1, wherein the reflective coating comprises one or more reflective coatings.

8. The method of claim 1, wherein the smoothing layer comprises one or more smoothing layers.

9. The method of claim 1, wherein the smoothing layer comprises hydrogen silsesquioxane (HSQ), a dielectric, an inorganic polymer, a photoresist, a polyimide, an amorphous film, or an ozone cured material.

10. The method of claim 1, wherein a thickness of the smoothing layer comprises 200 to 800 nm, 100 to 600 nm, up to approximately 1 μm, or thick enough to reduce a surface roughness of the grating substrate by a factor of approximately 4 to 7.5.

11. The method of claim 1, wherein the optical grating is included in an extreme ultra violet (EUV) lithography system.

12. A method for using an optical grating, the method comprising:
in response to a light incident on the optical grating, selectively reflecting a first component of the light at a first wavelength while selectively rejecting a second component of the light at a second wavelength, a reflectance efficiency corresponding to the selective reflection of the first component of the light being a function of a surface roughness of an intermediate layer included in the optical grating; and
outputting the selective reflection of the first component of the light at the first wavelength to an optical component included in an extreme ultra violet (EUV) lithography system, wherein the first wavelength is an EUV wavelength and the reflectance efficiency is maximized at the first wavelength.

13. The method of claim 12, wherein the first wavelength is 13.5 nm or 13.4 nm.

14. The method of claim 12, wherein the selective rejection of the second component of the light comprises preventing the second component of the light from being outputted to the optical component.

15. The method of claim 12, wherein the intermediate layer comprises one or more intermediate layers.

16. The method of claim 12, wherein the intermediate layer comprises an ozone cured smoothing layer.

17. The method of claim 12, wherein the intermediate layer comprises hydrogen silsesquioxane (HSQ), a dielectric, an inorganic polymer, a photoresist, a polyimide, an amorphous film, or an ozone cured material.

18. The method of claim 12, wherein the optical grating includes a reflective coating over the intermediate layer and the intermediate layer provided over a grating substrate having a grating profile.

19. The method of claim 19, wherein a major plane of the grating profile is flat, planar, curved, or concave.

20. The method of claim 19, wherein a cross-section of the grating profile comprises a square wave cross-sectional shape.

21. The method of claim 19, wherein a thickness of the intermediate layer comprises 200 to 800 nm, 100 to 600 nm, up to approximately 1 m, or thick enough to reduce a surface roughness of the grating substrate by a factor of approximately 4 to 7.5.

22. The method of claim 12, wherein the surface roughness of the intermediate layer is in a single digit Angstrom range.

23. The method of claim 12, wherein the reflectance efficiency at the first wavelength is approximately 70%.

24. The method of claim 12, wherein the second wavelength comprises a wavelength at least within approximately 1 nm on either side of the first wavelength.

25. The method of claim 12, wherein the selectively rejecting of the second component of the light comprises diffracting the second component of the light at an angular position not coincident with the optical component.

26. The method of claim 12, wherein the selectively rejecting of the second component of the light comprises outputting the second component of the light at a low reflectivity relative to the first component of the light.

27. A method for fabricating an optical component, the method comprising:
depositing one or more smoothing layers over a grating profile included at a grating substrate, the grating profile configured to facilitate selective reflection of a light at a first wavelength and selective rejection of the light at a second wavelength, the first wavelength being an extreme ultra violet (EUV) wavelength; and
curing the deposited one or more smoothing layers using ozone, wherein each of the one or more smoothing layers is cured before deposition of the next of the one or more smoothing layers, and wherein a surface roughness of the cured smoothing layers is in a single digit Angstrom range.

28. The method of claim 27, wherein the depositing of the one or more smoothing layers comprises spin coating the one or more smoothing layers.

29. The method of claim 27, wherein a thickness of the one or more smoothing layers comprises 200 to 800 nm, 100 to 600 nm, up to approximately 1 μm, or thick enough to reduce a surface roughness of the grating substrate by a factor of approximately 4 to 7.5.

30. The method of claim 27, wherein the one or more smoothing layers comprises hydrogen silsesquioxane (HSQ), a dielectric, an inorganic polymer, a photoresist, a polyimide, or an amorphous film.

31. The method of claim 27, further comprising depositing one or more reflective layers over the cured smoothing layers, a surface roughness of the reflective layers being approximately the same as the surface roughness of the cured smoothing layers.

32. The method of claim 31, wherein approximately 70% of the light at the first wavelength incident on the reflective layers is selectively reflected.

33. The method of claim 31, wherein a reflectance efficiency of the reflective layers at the first wavelength is a function of the surface roughness of the cured smoothing layers.

34. A semi-finished optical product, comprising:
a grating substrate including a square wave cross-sectional shape grating profile, dimensions of the grating profile selected to facilitate selective reflection of light at a first wavelength and selective rejection of the light at a second wavelength; and
one or more smoothing layers over the grating substrate, the smoothing layers configured to attenuate a surface roughness of the grating profile by having a smoothing layers surface roughness that is less than the surface roughness of the grating profile by a factor of approximately 4 to 7.5 while retaining the selective reflection and rejection properties of the grating profile.

35. The product of claim 34, further comprising one or more reflective layers over the smoothing layers, a reflectance efficiency of the reflective layers at the first wavelength being a function of the smoothing layers surface roughness.

36. The product of claim 35, wherein the first wavelength is 13.5 nm and the reflectance efficiency at the first wavelength is approximately 70%.

37. The product of claim 34, wherein the smoothing layers comprises ozone cured smoothing layers.

38. The product of claim 34, wherein the smoothing layers comprises hydrogen silsesquioxane (HSQ), a dielectric, an inorganic polymer, a photoresist, a polyimide, or an amorphous film.
